(19) United States
(12) Patent Application Publication
(10) Pub. No.: US 2003/0150220 A1
(43) Pub. Date: Aug. 14, 2003

(54) Continuous cryopump with a device to chip and remove ice from the cryopump chamber

(76) Inventor: Christopher Foster, Clinton, TN (US)

Correspondence Address: Christopher A. Foster, 450 Bacon Springs Lane, Clinton, TN, 37716, US

(21) Appl. No.: 10/314,867

(22) Filed: Dec. 9, 2002

Related U.S. Application Data
(60) Provisional application No. 60/337,791, filed on Dec. 10, 2001.

(51) Int. Cl. B01D 8/00; F25D 21/00

(52) U.S. Cl. 62/55.5; 62/272

(57) ABSTRACT

A high throughput continuous cryopump is provided. The continuous cryopump consists of a cryocondensation cryopump employed to pump a process gas. The gas is pumped by condensing and freezing the gas onto a refrigerated cryosurface contained in the pump chamber, thereby causing an ice layer to build up on the cryosurface. The continues cryopump also contains a mechanism to cut the ice layer into small pellets or chips. The ice chips removed from the ice layer are gathered and routed into a separate ice collection chamber by a funnel system. Periodically, the ice collection chamber is isolated from the cryopump chamber by an isolation valve and the ice chips in the collection chamber are melted (or evaporated) and removed from said collection chamber. The regeneration of the ice chips collected in the ice collection chamber which has a relatively small volume, can produce very large exhaust pressures, thereby allowing a relatively small auxiliary pump to evacuate the collection chamber. The cryopump chamber, being isolated from the collection chamber during the regeneration, can remain in full pumping operation during the regeneration of the collection chamber, so that the cryopump is capable of operating continuously.

The benefit of Provisional Application Ser. No. 60/337,791 filed Dec. 10, 2001 and entitled CONTINUOUS CRYOPUMP WITH A DEVICE TO PELLETIZE AND REMOVE ICE FROM THE CRYOPUMP CHAMBER, is hereby claimed. The disclosure of this referenced provisional application is incorporated herein by reference.

### BACKGROUND OF THE INVENTION

The invention relates generally to a method of exhausting gases at a high rate from vacuum process chambers. Cryopumps remove such gases by freezing them out on surfaces maintained at temperatures well below the temperature at which the gases are in vapor-solid equilibrium at the chamber pressure. The gases stick to the refrigerated surfaces and build up as a layer of solid ice or frost. The pumping process can continue as long as the surface of the ice layer remains cold or until the cryochamber is filled with ice. In many instances, for example when pumping radioactive, explosive or poisonous gases, it may be desirable to limit the amount of frozen gas stored in the pump. Typically, when using conventional cryopumps, the ice built up in the pump is periodically removed in a process referred to as regeneration. The regeneration process for conventional cryopumps is achieved by the sequence of: A) isolating the cryopump from the process chamber with a valve; B) allowing the pump to warm up while evacuating the evaporating frozen gases stored within the pump with a secondary pumping system; C) recooling the cryopump and; D) reopening the isolation valve. In this case the primary processing chamber is either idled during the regeneration of the cryopump, or a second cryopump is valved in to take the place of the pump being regenerated. Some process chambers are constructed with large cryopumping surfaces built directly into the chamber. In this case the pumps cannot be isolated with a valve, which requires that the entire chamber must be taken out of service during the cryopump regeneration. Conventional cryopumps are commonly used to evacuate chambers with low gas loads, so that the pumps do not require regeneration very often. However, in many processes large quantities of gases are continuously injected or produced in the process chamber; thereby requiring the pumps to evacuate large quantities of gas and be regenerated frequently. This is commonly referred to as a high throughput system. Conventional cryopumps are often not chosen for pumping high throughput processes, when the regeneration cycles become inconveniently frequent.

A continuous cryopump (Foster, U.S. Pat. No. 4,724,677) was developed which incorporates a regeneration head which continuously removes the cryofrost deposits while the pump is in operation. In this pump, the frost is shaved from the cryosurface into a chamber within the regeneration head. A heating element within the head chamber evaporates the shaved ice. The gas produced is evacuated from the regeneration head chamber through a hose connected to a secondary pump. An alternate embodiment of this pump is constructed so that the regeneration head contacting the ice is a heated perforated plate designed to sublime the ice directly into the regeneration head chamber as opposed to shaving the ice. Both of these embodiments produce a continuous cryopump which can remain in service indefinitely while limiting the amount of frozen material in the pump. While this system works well for gases such as hydrogen which produces a soft ice, some gases which produce very hard ices are more difficult to remove. Also, when pumping mixtures of gases with widely varying freezing points, the evaporation of the ice in the head may be problematic. A third limitation is that the achievable compression ratio of the pump is limited by the leakage of the gases from the secondary chamber back into the primary pumping chamber.

Another continuous cryopump (Foster, U.S. Pat. No. 6,003,332) was developed which provides a cryosurface which is subdivided into an array of pellet shaped cells. The ice thereby grows in the cells in the form of pellets. By warming individual or groups of cells, the pellets partially sublime and detach from the cell while the remaining cold cells remain in the pumping cycle. The pump is designed so that the released pellets fall out of the freezing cells and are transferred under the influence of gravity through a funnel system into a small secondary chamber external to the primary pumping chamber. The collection chamber can then be periodically valved off and regenerated while the primary pumping chamber remains in service. Since the pellets are collected in a relatively small chamber which can be largely filled with pellets, very large pressures can be achieved during the regeneration process, thereby producing a pumping system with very large compression ratios. A problem with this pumping system is the complexity of the cryopumping surfaces, which must be thermally cycled to achieve the release of the pellets. In addition, when pumping mixtures of gases with widely varying freezing temperatures, the pellets may not release well from the cells.

Accordingly it is an object of the present invention to produce a continuous cryopump capable of pumping a wide variety of gases at very high compression ratios using a simple cryosurface which does not require thermal cycling of the cryosurface during regeneration.

Other objects and advantages of the present invention will be recognized upon reading the detailed description together with the drawings described as follows.

### SUMMARY OF THE INVENTION

This invention is directed to a high throughput continuous cryopump. The cryopump incorporates an improved method of regenerating the cryopumping surface while the pump is in continuous operation. The regeneration of the cryopumping surface does not thermally cycle the pump, and to this end a device serves to cut the ice deposited on the cryosurface into small pieces or chips. The freed ice chips drop down and through an isolation valve into a secondary collection chamber. The ice chip collection chamber can be periodically valved off from the pump chamber and regenerated while the cryopump remains in operation.

A characteristic of frozen chipped ice, utilized in this invention, is that they can be conveyed, much like a fluid, by various means and techniques known to chemical engineers. For example, properly sized funnels, pipes, auger screws, hoppers, valves and vibrators combined with transport means of gravity and/or flowing gases can be used to transport chips from one chamber to another. Chips of frozen gases also exhibit a characteristic of being able to slide with very low friction on smooth surfaces which are maintained at a temperature above the evaporation temperature of the ice. The fluid nature of the chips is utilized in this invention to allow the ice chips removed from the cryosurface to be conveyed out of the pump, by funnels, tubes, and gravity, into a small secondary collection chamber. The collection chamber can then be periodically isolated from the primary chamber with a valve and independently regenerated, while the primary pump remains in operation.

### BRIEF DESCRIPTION OF THE DRAWINGS

FIG. 1 is a side elevation partly in section of an improved high throughput continuous cryopump constructed in accordance with various features of the present invention.

FIG. 2 is a partial top elevation of the pump shown in FIG. 1 showing the cryopumping surface, the frozen ice just before and after being cut by the rotary milling cutter, the ice chips and the collection funnel.

FIG. 3 is a side elevation partly in section of an alternate embodiment of an improved high throughput cryopump constructed in accordance with various features of the present invention.

### DETAILED DESCRIPTION OF THE ILLUSTRATED EMBODIMENTS

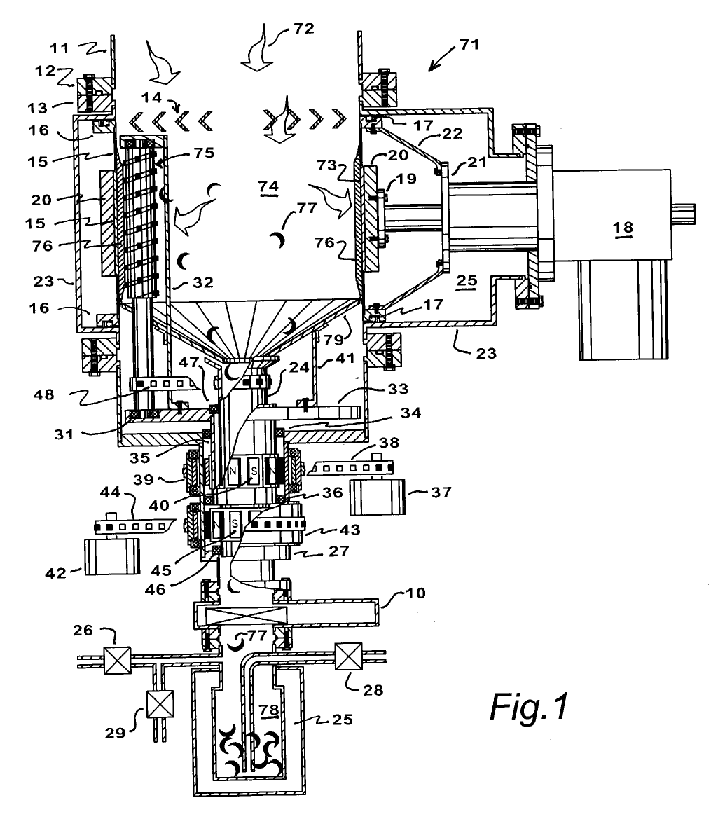

A cross sectional view of a continuous cryopump 71 which is an embodiment of the invention is shown in FIG. 1. The pump 71 is of the cryocondensation type, i.e it pumps by condensing and freezing a process gas 72 to a solid ice form 76 on a refrigerated surface 73. The cryopump 71 is mounted external to a process chamber being pumped (not shown) and is connected to the process chamber by an 8″ OD tube 11 terminated with a vacuum flange 12. The flange 12 connects to cryopump 71 at a mating cryopump inlet flange 13. The gas or vapor 72 being pumped, enters the cryopump 71 through said inlet flange 13. The vapors 72 then pass through an inlet baffle 14, into the cryopump chamber 74. The cryochamber 74 is formed by a short stainless steel tube 15 which is brazed to copper flanges 16 on each end. The cryochamber 74 is encased within a box shaped vacuum dewar enclosure 23 which is provided to thermally insulate the cryochamber 74. The cryochamber 74 is isolated from vacuum enclosure 23 by a pair of spring loaded Teflon seals 17 placed between copper flanges 16 and the inside walls of enclosure 23. The center portion of said cryopump chamber 74, the cryosurface 73, is maintained at a temperature substantially below the equilibrium vapor pressure-temperature of the process gases 72. For example, if the process gas 72 to be pumped is argon gas at a desired inlet pressure of 1×10⁻³ Torr, then the cryosurface 73 can be maintained at a temperature of 30K, at which temperature argon has a solid-vapor equilibrium pressure of below 1×10⁻⁶ Torr. At these low temperatures, the process gases 72 striking the cryosurface 73 are substantially frozen to the cryosurface 73 and build up as a layer of solid ice 76. The cryosurface 73 is maintained at the desired temperature by refrigeration means, which in the embodiment shown in FIG. 1 is provided by a Gifford/McMahon cycle refrigerator cold head 18, which has a low temperature stage 19. The low temperature stage 19 is connected mechanically and thermally to a thick walled copper belt 20 surrounding and soldered to the center section of the cryochamber tube 15, thereby cooling the cryosurface 73. Said cryochamber tube 15 is also reduced in thickness between the cryosurface 73 connected to copper belt 20 and the copper end flanges 16 so as to limit the flow of heat through said tube 15 to said cryosurfaces 73 from the enclosure 23 which is at ambient temperature. The inlet baffle 14 is refrigerated by an intermediate temperature stage 21 of the cold head 18. The baffle 14 is attached and thermally connected to copper flange 16 which in turn is thermally connected to the intermediate temperature stage 21 of cold head 18 by a set of copper straps 22. The inlet baffle is thereby maintained at a temperature of about 90K which is above the freezing temperature of the gases 72 but substantially below ambient temperatures. The inlet baffle 14 thus serves to lower the temperature of the gases 72 entering the cryopump chamber 74, thereby improving the thermal efficiency of said cryopump 71. The use of said cold inlet baffle 14 is a common practice with conventional cryopumps. The vacuum enclosure 23 surrounds and contains the cryochamber 74 and the cold stages 19 and 21 of cold head 18 and is provided as thermal insulation means for the cold parts of the pump. The cryopump chamber 74 is substantially isolated from the vacuum enclosure 23 by seals 17, thus preventing process gases 72 from entering enclosure 23 where they might freeze onto the cold parts contained therein. The cryopump 71 is thus designed so that the process gases 72 freeze out only on the cryosurface 73.

In a conventional cryopump, the gases 72 freezing onto the cryosurface 73 build up as a layer of ice 76 until the pump is taken out of service and regenerated. The ice layer 76 can become very thick and in some cases can build up until it forms a solid block largely filling the cryochamber 74 volume. This invention limits the build up of the ice layer 76 to a desired thickness by continuously or periodically removing the ice by a cutting or machining means. The embodiment shown in FIG. 1 uses a rotary chipper 75 which is a roughing end mill used commonly with milling machines to machine metals such as aluminum. The chipper 75 has an active cutting length extending beyond the actively cooled cryosurface 73 since the ice 76 tends to freeze out somewhat beyond the actively cooled cryosurface 73. A desired feature of the chipper 75 is that it removes the ice from the cryosurface 73 in individual pieces or chips of ice 77 as opposed to long strings or thin ribbons. By converting said ice 76 into said ice chips 77 the collection and conveyance of said ice 77 out of the pumping chamber is facilitated. The roughing milling cutter 75 produces chips of material. Many other cutting devices used to machine plastics, wood or metals could also be used. The cutter 75 is mounted in the cryochamber 74 with a mechanism that allows the cutter to rotate about its axis and also to sweep about the center of the chamber 74 so as to machine the ice from the entire cryosurface 73. The embodiment shown in FIG. 1 also allows for the cutter to be mounted slightly away from the cryosurface 73, with a clearance of a few millimeters so that the cutter never contacts the metal wall. In operation, the ice layer 76 is allowed to build up to a thickness greater than the cutter gap thickness, before machining it back with cutter 75.

The ice chips 77 fall, by gravity, down and onto a funnel pan 79 mounted in the bottom of said chamber 74. Said ice chips flow out of the funnel 79 into an open tube 24 with a diameter substantially larger than the ice chips so as to prevent the ice chips from becoming clogged in the tube 24. The ice chips 77 proceed to drop through an open isolation gate valve 10 and into ice collection chamber 78 where they collect. The ice collection chamber 78 is provided with vacuum insulation space 25 and/or active cooling(not shown), thus limiting or eliminating the re-evaporation of the ice chips 77 during the chipping and collecting phase of the cryopump 71.

When a desired amount of ice chips 77 have collected in ice collection chamber 78, the ice can be removed or regenerated from said ice collection chamber 78. Various procedures for regenerating conventional cryopumps can be used to regenerate the ice collection chamber 78. A rapid regeneration technique is used with cryopump 71. This consists of injecting pressurized gas, preferably of the same type as the process gas 72, into the isolated ice collection chamber. This regeneration process is accomplished by the sequence of: A) turning off said cutter 75 so that no new chips 77 are being formed; B) closing isolation valve 10; C) opening a gas injection valve 26 injecting pressurized process gas 72, from an external vessel (not shown) into ice collection chamber 78 causing the gas 72 to condense on and melt ice chips 77; D) opening exhaust valve 28 thus allowing the now liquified chips 77 to be blown out of ice collection chamber 78; E) closing injection valve 26 and exhaust valve 28; F) opening pumpout valve 29 connected to an auxiliary vacuum pump (not shown), thereby evacuating the remaining process gas 72 from chamber 78; G) closing pumpout valve 29 and re-opening isolation valve 10.

After the regeneration is completed the cryopump can continue to operate until a desired thickness of ice 76 has formed on cryosurface 73. Then the cutter 75 can be turned on to remove the new deposits of ice 76 and collect them in the ice collection chamber 78, thus completing the cycle of the pumping/regeneration process. The cryopump 71 can remain in full pumping operation during all of the phases of the chipping and regeneration cycles.

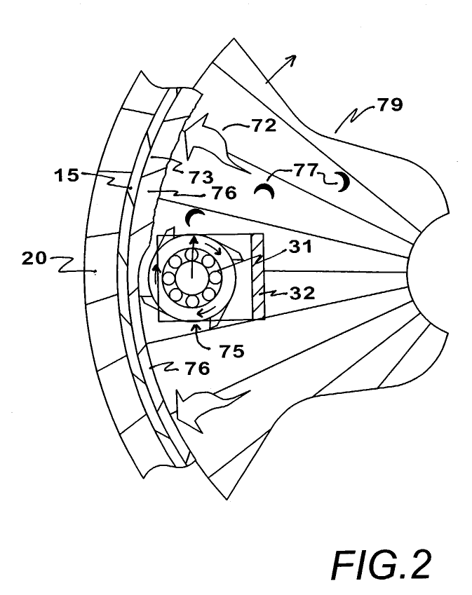

Aa partial top elevation of the pump shown in FIG. 1 showing the cryopumping surface, the frozen ice just before and after being cut by the rotary milling cutter, the ice chips and the collection funnel is shown in FIG. 2. The cutter 75 is mounted on cutter bearings 31 supported by a support bracket 32. Cutter 75 is rotated about its axis and swept about the center of the cryochamber 74 thus passing over all the cryosurface 73 causing ice layer 76 to be cut into small chips 77 which fall under the influence of gravity into funnel 79. Said process gas 72 continues to freeze out on the refrigerated ice layer 76 during the cutting action.

The cutter drive assembly and the ice chip collection funnel is shown in FIGS. 1 and 2. The cutter drive consists of a set of bearings and drive mechanisms designed to rotate the cutter blades so as to cut the ice on the cryosurface and is also designed to sweep the cutter over the cryosurface 73. The assembly shown utilizes motors external to the pump chamber connected to magnetically coupled vacuum feedthroughs to provide the driving means. The cutter 75 and cutter support bracket 32 are mounted on a turntable 33 which rotates about the center axis of the cryochamber 74. The turntable is mounted on and driven by an outer drive tube 35 which is supported on a turntable bearing 34 and a lower turntable bearing 36. A slave magnetic drive ring 40 consisting of a 94PH stainless steel ring on which are mounted a set of permanent magnets is attached to drive-tube 35. The drive ring 40 fits inside a lower vacuum chamber tube 27 with a small clearance. A mating master turntable magnetic drive ring 39 is mounted on bearings outside vacuum tube 27. The master drive ring is driven by turntable drive motor 37 using drive belt 38. The chip collection funnel 79 is mounted to the turntable 33 by support brackets 41. The ice chips 77 exiting the funnel 79 enter and pass through the center tube 24 to the gate valve 10. The center tube 24 also serves to drive the cutter 75 using metal belt 48. The cutter drive tube 24 passes through the turntable drive tube 35 and is mounted to the center of the turntable 33 with an upper bearing 47 and to the vacuum chamber tube 27 by lower bearing 46. The cutter drive tube 24 is driven by a second magnetic drive consisting of drive motor 42, belt 44, master magnetic ring 43, and slave magnetic ring 45 which are similar to the turntable drive components 37, 38, 39, 40 described above.

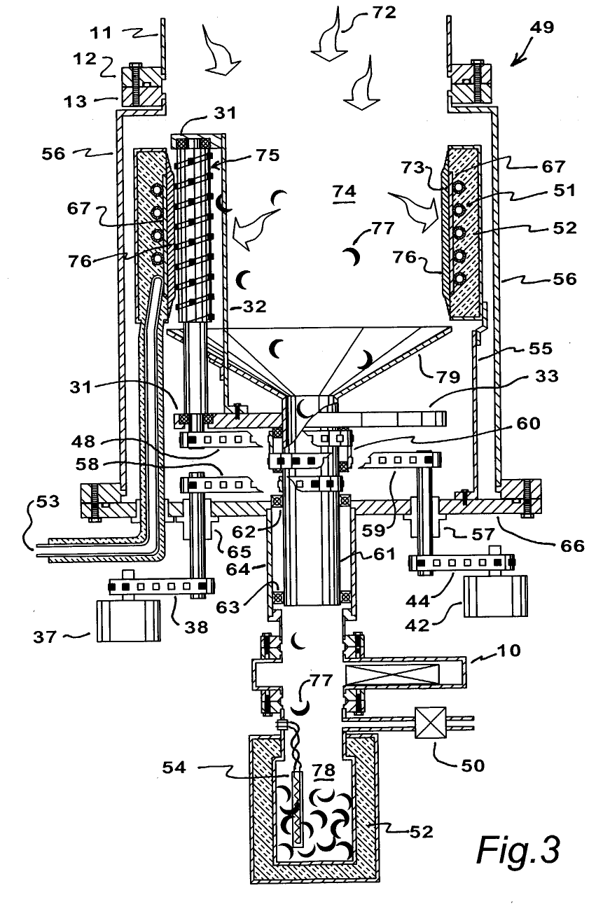

An alternate embodiment of the continuous cryopump 71, cryopump 49 is shown in FIG. 3. Cryopumps 71 and 49 are both cryocondensation pumps and have many parts and functions which are similar. Both pumps 71 and 49 are connected to a process chamber (not shown) having an exhaust flange 12 connected to the pump entrance flange 13. The process gases 72 enter the cryochamber 74 and are cryo-condensed onto refrigerated cryosurface 73 forming the cryo-ice deposit 76. Periodically, a cutter mechanism 75, which is mounted on the turntable 33 with bracket 32 and bearings 31, is activated to remove the cryo-ice 76 forming the ice chips 77. The Ice chips 77 are collected with the funnel 79 and drop through the valve 10 into the ice chip collection chamber 78. The cutter is energized by motor 42 through belt 44 and the turntable is energized by motor 37 through belt 38. The differences between alternate cryopump 49 and cryopump 71 include the pump housing, the refrigeration means, the thermal insulation means, the turntable mounting, the rotary vacuum feedthrough used to activate the turntable, the rotary feedthrough used to activate the cutter and the collection chamber regeneration means. The housing which forms cryochamber 74 in cryopump 49 shown in FIG. 3 consists of a cylindrical housing 56 which connects the inlet flange 13 to a lower flange 66. A pump exhaust tube 64 is welded to the center of flange 66 at one end and connects with flanges to the exhaust valve 10 on the other end. The cryopump 49 employs a fluid refrigeration means. The refrigerant, e.g. liquid nitrogen, enters the pump through an insulated tube 53 which is connected to a tubing coil 51 soldered to the outside surface of a nickel plated copper belt 67. The refrigerant then exits the pump through an insulated exhaust line (not shown) similar to the inlet line 53. The inside surface of the nickel plated copper belt 67 forms the cryosurface 73. All of the other cold surfaces including the refrigerant lines 53, the back surface of the copper belt 67 and the refrigerant coils 51 are coated with a thermal insulation coating 52 consisting of an epoxy filled with glass microballons, available as STYCAST 1090. The coating 52 reduces the amount of heat transmitted to the cryosurface 73 from the housing 56 and also serves to retard the growth of ice on those parts which are not serviced by the cutter mechanism 75. The copper belt 67 and refrigerant coils 51 are mounted in the center of housing 56 by a set of low thermal conductivity brackets 55 attached to the lower flange 66. Mounted co-axially within the lower housing tube 64 on bearings 62 and 63 is a rotatable transfer tube 61 which extends into the lower section of housing 56. The turntable 33 and the collection funnel 79 are attached to and turn with said transfer tube 61. A rotary vacuum feedthrough 65, such as those manufactured by FerroFluidics is mounted off-axis on the lower flange 66 and is used with drive belt 38 and an internal drive belt 58 to couple the drive motor 37 to the center tube 61, thus providing rotary motion means to turntable 33 which in turn provides the motion of the cutter assembly 75 around the center axis of the copper belt 61 so as to sweep the cutter 75 over the entire cryosurface 73. The cutter is also turned about its own axis by a metal belt 48 which is connected to a transfer pulley 60 which turns about center tube 61 on bearings. The transfer pulley 60 is coupled to the shaft of a second rotary feedthrough 57 with inner belt 59. The rotary feedthrough 57 is coupled to the cutter drive motor 42 with belt 44, thereby providing rotary motion means to the cutter 75. The regeneration cycle of the collection chamber of cryopump 49 shown in FIG. 3 is accomplished by the sequence of: A) closing valve 10, B) opening exhaust valve 50 which is connected to an auxiliary vacuum pump (not shown), C) energizing an electric heating element 54 located inside collection chamber 78, causing the ice chips 77 to sublime and be evacuated through valve 50 and D) closing valve 50 and opening valve 10, thereby completing the cycle. The collection chamber 78 is encased in the epoxy microballon coating 52 which is provided to thermally insulate the collection chamber, thereby minimizing the evaporation of the ice chips 77 during the collection cycle.

It will be noted that numerous modifications and substitutions can be had to the aforedescribed embodiments without departing from the spirit of the invention. For example, the continuous cryopump depicted in FIGS. 1 and 2 is designed to pump argon at a gas throughput of 8 Torr liters per second and a volumetric speed of approximately 2,500 liters per second. Since the pump works by freezing the gas on refrigerated surfaces, the pump components need to be chosen with consideration given to the properties of the specific process gases being pumped. For example, helium gas does not freeze out in a cryocondensation pump, so that the continuous cryopump 71 would not be a good pump for pumping helium, although it could be used in a system to remove impurity gases from helium. In general, the cryosurface temperature is chosen to be below the vapor equilibrium temperature of all of the gas species which are to be pumped. Very low temperatures however may not be desirable for a given process, since the refrigeration means used to cool the pumping cryosurfaces become more complex as the temperature is lowered. For example, if the pump is designed to pump chlorine gas at 10⁻³ Torr the refrigeration means should be capable of producing a cryosurface temperature below 117 Kelvin. This would allow a single stage G/M refrigerator operating at 90K to be substituted for the two stage G/M refrigerator 18 used with cryopump 71. The entrance baffle 14 would also be removed to avoid the process gas from condensing on it. A gas such as chlorine could also be pumped with cryopump 49 shown in FIG. 3 using liquid nitrogen at 77K as the refrigeration means. When pumping a mixture of gases, for example argon and chlorine, then the cryosurface should be low enough to pump argon, i.e. below about 40K and the baffle should be at a temperature high enough to not condense the chlorine, i.e. above 117K.

The cryopump 71 shown in FIGS. 1 and 2 is designed to pump at a speed of about 2,500 liters/s for argon. However if higher speeds are desired a larger pump (inlet flange and cryosurface area) would be used. Alternatively a smaller pump could be used for lower pumping speeds.

The cryosurface 73 in cryopumps 71 and 49 is the inside surface of an open cylinder. This shape was chosen so that a relatively simple cutter mechanism could be used to cover the entire cryosurface. However other shapes and sizes of the cryosurface could be employed by changing the drive system and geometry of the cutter mechanism and/or by employing multiple cutter mechanisms. For example, a disk or set of disks could be used as the cryosurface with a caliper shaped cutter, or flat panels could be used with a linear or traverse sweep mechanism for the cutter.

It is desirable that the funnel system to collect the ice chips be maintained at a temperature high enough to prevent the process gas being pumped from freezing out on it, and preferably high enough to establish a gas bearing between the chips and the funnel surface in order to reduce friction, thus facilitating the collection of the ice chips. Alternative collection schemes could also be employed, such as a screw auger or bucket chain collector which could be used when the pump geometry did not allow a simple gravitational flow of the chips out of the cryochamber and into the secondary collection chamber.

The isolation valve in the cryopumps 71 and 49 is a vacuum gate valve. Other valves which allow the chips to flow through them, such as an angle valve tipped at an angle of 45 degrees or a ball valve could be used. For continuous output of ice chips, a set of valves in a load lock configuration or a rotary valve could be used. Cryopumps 71 and 49 utilize a rotary cutter to remove the ice from the cryosurface and produce chips. Alternative ice removal mechanisms which produce pellets or chips small enough to be transported into the collection chamber could also be employed. For example an oscillating rasp file type cutter could be used or one or more serrated scraper blades which are propelled over the surface so as to cut the ice in a diamond pattern, thereby forming chips, could be employed.

Accordingly, the aforedescribed embodiments are intended for the purpose of illustration and not as limitation:

I claim:

1. A cryopump adapted for regeneration during cryopumping operation for pumping a process gas comprising:
a chamber or pump chamber in fluid communication with the process gas to be pumped containing a pumping surface against which said process gas is to condense and freeze, said pumping surface provided with refrigeration means for lowering its temperature to a temperature substantially below the solid-vapor equilibrium temperature of said process gas at the desired operating pressure of said chamber so that said process gas freezes onto and is bonded to said pumping surface,
a chipper to remove said ice from said pumping surface, said chipper forming a multitude of particles or chips of said ice which are substantially free from said pumping surface, said chipper removing said ice from said pumping surface without substantially changing the temperature of said pumping surface thereby allowing said cryopump to remain in continuous pumping operation,
a collection chamber positioned below said pumping surface, said collection chamber inter-connected to an opening in the pump chamber with a flow transfer valve, said collection chamber further provided with means for exhausting said ice chips, said flow transfer valve isolating the internal pressures of said pump chamber and said collection chamber from one another to facilitate the removal of said ice chips from said collection chamber without affecting the pressure in said pump chamber, thereby allowing said cryopump to remain in continuous pumping operation,
a collection conduit between said pumping surface and said flow transfer valve for collecting and routing the freed ice chips, under the influence of gravity, into and through said flow transfer valve into said collection chamber.

2. The cryopump of claim 1 wherein the surfaces connected to or in thermal contact with said cryopumping surface, but which are not provided with said chipping means, are provided with thermal insulation means so as to limit or prevent condensation of said process gases on said connecting surfaces, thereby limiting the accumulation of condensed process gases within the cryopump housing and increasing the thermal efficiency of the cryopump.

3. The cryopump of claim 2 wherein the thermal insulation means is provided by a secondary vacuum enclosure or dewar surrounding the cryopumping surface.

4. The cryopump of claim 2 wherein said thermal insulation means is provided by a coating of a low thermal conductivity material.

5. The cryopump of claim 1 wherein said chipper is provided with motive means to pass over substantially all of said cryopumping surfaces, thereby limiting the quantity of ice contained in the cryopump.

6. The cryopump of claim 5 wherein said chipper consists of a rotating cutter provided with a plurality of cutting edges, said rotating cutter provided with means for positioning the cutter adjacent to said cryopumping surfaces so as to allow the cutting edges to come close to the cryopumping surface, but not to make direct contact with the cryopumping surface, thereby allowing said rotating cutter to remove all but a thin layer of said solid ice during its passage over said cryopumping surface, while preventing damage to said cryopumping surface by said cutter head.

7. The cryopump of claim 5 wherein said chipper consists of a serrated blade or file, said file provided with motive means so as to cut chips of ice.

8. The cryopump of claim 1 wherein said collection conduit consists of one or more sloped collecting surfaces, said collecting surfaces maintained at a temperature above said vapor solid equilibrium temperature, said collecting surface being substantially smooth, and said collecting surfaces shaped and oriented so that said ice chips falling into said collecting surfaces are caused by gravity to slide into said transfer valve.

9. The cryopump of claim 1 wherein said exhausting means for said collection chamber is provided by a collection chamber heating means, said heating means causing said ice chips contained within said collection chamber to vaporize, thereby filling the collection chamber with the evaporated process gas at a pressure substantially higher than the pressure in said chamber, said collection chamber also provided with pumping means for removing said evaporated process gas.

10. The cryopump of claim 9 wherein the collection chamber is a first storage vessel, the cryopump includes a second storage vessel and the transfer valve is adapted to alternately allow said ice chips to flow into the first storage vessel while isolating the second storage vessel from the chamber and visa versa, thereby allowing one storage vessel to be exhausting said ice chips while the other is collecting said ice chips from said chamber.

11. The cryopump of claim 1 wherein the means for exhausting said collection chamber is provided with means to inject compressed process gas at a pressure above the triple pressure of said process gas, thereby causing said compressed process gas to condense on said ice chips, causing said ice chips to melt to liquid, said collection chamber further provided with a liquid exhaust valve to allow the liquid to be blown out of said collection chamber by said pressurized process gas.

12. The cryopump of claim 1 wherein the collection chamber is provided with thermal insulation means so as to limit the evaporation of said ice chips contained in said collection chamber during the ice chip collection cycle of the cryopump.

13. The cryopump of claim 1 wherein the process gas contains at least one of a group consisting of hydrogen, deuterium, tritium, neon, argon, krypton, nitrogen, oxygen, fluorine, methane, carbon dioxide, silane, arsine, xenon, ammonia, silicon fluoride, hydrogen chloride, uranium hexafluoride, and gaseous compounds of carbon.
